(19) United States
(12) Patent Application Publication
(10) Pub. No.: US 2023/0053770 A1
(43) Pub. Date: Feb. 23, 2023

(54) ANIMAL LITTER AND BEDDING

(71) Applicant: Rem Brands, Inc., Walton, KY (US)

(72) Inventors: David Schneider, Union, KY (US); Jonathan Schneider, Walton, KY (US)

(21) Appl. No.: 17/971,209

(22) Filed: Oct. 21, 2022

Related U.S. Application Data
(63) Continuation-in-part of application No. 16/521,212, filed on Jul. 24, 2019.
(60) Provisional application No. 63/270,819, filed on Oct. 22, 2021.
(60) Provisional application No. 62/703,751, filed on Jul. 26, 2018.

(51) Int. Cl. A01K 1/015

(52) U.S. Cl. CPC A01K 1/0155

(57) ABSTRACT

Antimicrobial and odor control animal-related material compositions used to form animal litter or bedding include a base material and a halo active aromatic sulfonamide compound of Formula (I):

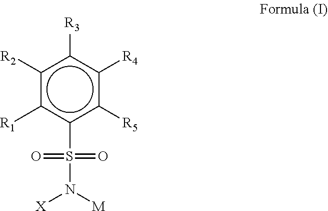

wherein the variables R₁, R₂, R₃, R₄, R₅, X, and M are disclosed herein. The resulting animal litter or bedding maintain antimicrobial and odor-controlling properties over extended time periods.

### CROSS-REFERENCE TO RELATED APPLICATIONS

This application claims priority to U.S. Provisional Patent Application Ser. No. 63/270,819, filed on Oct. 22, 2021, which is incorporated by reference in its entirety. This application is also a continuation-in-part of U.S. patent application Ser. No. 16/521,212, filed on Jul. 24, 2019, which claims priority to U.S. Provisional Patent Application Ser. No. 62/703,751 filed Jul. 26, 2018, the entireties of which are incorporated by reference herein.

### BACKGROUND

The present disclosure relates to animal litter and bedding materials for pets and animals having antimicrobial and odor-controlling characteristics. The litter and materials comprise a halo active aromatic sulfonamide compound, which can provide effective and long-lasting antimicrobial action as well as odor reducing properties. The antimicrobial and anti-odor animal litter, bedding materials, and associated processes find particular usefulness in settings and environments where exposure to bacteria and other microorganisms are prevalent and/or odor control is desired.

Animal urine and feces may be a serious hazard because they may contain microorganisms that are both pathogenic to humans and animals, and resistant to several classes of antibiotics. Conventional measures against contamination by microorganisms and undesirable odors typically involves surface cleaning, such as, for example, spraying and wiping using various disinfectants. Normal efficacy testing for disinfectants, sterilants, and sanitizers measure performance after a 30-second to 10-minute kill time. These protocols are mandated by various agencies (EPA, AOAC, etc.) to qualify a formulation for registration to claim particular kill performance. However, it is known that products such as bleach, hydrogen peroxide, or peracetic acid are essentially ineffective after they have dried on the surface they are applied to and have almost no residual kill performance of microorganisms. It would be desirable to provide animal litter and bedding materials that themselves have extended killing performance and odor-controlling properties over longer periods of time.

### BRIEF DESCRIPTION

It has been found that certain halo active aromatic sulfonamide compositions, and processes using the same, can provide extended microorganism killing performance and can be embedded or otherwise incorporated into various animal litter and bedding materials to provide surfaces and structures (e.g., litter, tubs, boxes, blankets, bedding, and the like) with antimicrobial and odor-controlling properties. In certain circumstances, such surfaces and structures formed using the compositions of the present invention can exhibit a microbial kill performance that can extend for weeks to months and possibly years.

These and other non-limiting features or characteristics of the present disclosure will be further described below.

### DETAILED DESCRIPTION

A more complete understanding of the animal litter, bedding materials, and halo active aromatic sulfonamide compounds disclosed herein can be obtained by reference to the description below.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Halo active aromatic sulfonamide organic compounds have been known to reduce or eliminate odor. Their usefulness is predicated on their ability to release an active chloride ion when needed on demand, immediately after which they simultaneously generates an active aromatic sulfo nitrene companion ion. The chlorine atom has a +1 formal charge in a hypochlorite ion, ClO⁻, which is the form taken by the chlorine atom when dissociated from the sulfonamide compound. Reference to the chlorine atom as having a +1 or 1⁻ charge may be used in this application interchangeably because this terminology has no effect on the compound itself or its use.

It has been found in the present disclosure that halo active aromatic sulfonamide organic compounds also have an antimicrobial performance that can extend over long periods of time. This may be useful in various residential settings with animals such as residential homes and apartments, farms and ranches, as well as commercial settings such as pet stores, animal hospitals, kennels, zoos, animal daycare facilities, barns, stalls, out-buildings, coops, paddocks, pasture land, and the like. Whereas common disinfectants such as bleach, hydrogen peroxide, or peracetic acid are typically applied to a surface and then dry/evaporate within minutes, ending their disinfectant ability, it has been found that hydrates of halo active aromatic sulfonamide organic compounds will continue to exhibit disinfectant and odor-controlling ability over long time periods, such as over 24 hours, over 48 hours, over 72 hours, over 168 hours, or even as long as 336 hours (two weeks), or longer. It is believed that these compounds can also maintain such properties for longer periods, such as months or even years, so long as the halo active aromatic sulfonamide organic compound is present and has not been exhausted or decomposed. For example, the disinfectant and odor-controlling features may be maintained for at least 1 month, at least 2 months, at least 3 months, at least 4 months, at least 5 months, at least 6 months, at least 7 months, at least 8 months, at least 9 months, at least 10 months, at least 11 months, or at least 12 months, or more.

The halo active aromatic sulfonamide organic compounds also have several usage benefits over traditional disinfectants such as bleach or hydrogen peroxide. For example, bleach has a very strong chlorine odor in open air and during cleaning; is rapidly destructive for many surface types; only reduces microbes when wet, and has essentially no residual antimicrobial action once dry; has poor stability in “non-ambient” temperatures and light exposure; and is toxic, a skin and eye irritant, and a skin sensitizer. In contrast, compositions using halo active aromatic sulfonamide organic compounds can have equivalent antimicrobial performance, but also have long term residual antimicrobial action when dried on a surface; offer residual odor elimination when dry; have excellent stability, with a shelf life measured in years; and have extremely low toxicity, are not skin/eye irritating, and are not a sensitizer.

### Definitions

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

As used herein, the terms “wt %” or “weight percent” denote the amount (i.e., weight) of a component per 100 units of the composition (i.e., 1 wt % of component A based on the weight of the composition is equivalent to 1 gram of A in every 100 grams of the composition).

It is expressly contemplated that the disclosure of two or more values also discloses ranges with a combination of any two of such values. For example, the disclosure of the ranges “about 0.1 wt % to about 10 wt %” and “about 0.5 wt % to 5 wt %” should be construed as also disclosing the ranges “about 0.1 wt % to about 0.5 wt %” and “about 5 wt % to about 10 wt %”.

The term “ambient temperature” refers to a temperature of 20° C. to 25° C.

The present disclosure may refer to temperatures for certain process steps. It is noted that these generally refer to the temperature at which the heat source (e.g. furnace) is set, and do not refer to the temperature which must be attained by the material being exposed to the heat.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, the aldehyde group —CHO is attached through the carbon of the carbonyl group.

The term “alkyl” refers to a radical composed entirely of carbon atoms and hydrogen atoms which is fully saturated. The alkyl radical may be linear, branched, or cyclic, and such radicals may be referred to as linear alkyl, branched alkyl, or cycloalkyl.

The term “aromatic” refers to a radical that has a ring composition containing a delocalized conjugated pi composition with a number of pi-electrons that obeys Hückel's Rule. The ring composition may include heteroatoms (e.g. N, S, Se, Si, O), or may be composed exclusively of carbon and hydrogen. Exemplary aromatic groups include phenyl, thienyl, naphthyl, and biphenyl.

The term “aryl” refers to an aromatic radical composed exclusively of carbon and hydrogen. Exemplary aryl groups include phenyl, naphthyl, and biphenyl.

The term “heteroaryl” refers to an aromatic radical containing at least one heteroatom. Exemplary heteroaryl groups include thienyl. Note that “heteroaryl” is a subset of “aromatic”, and is exclusive of “aryl”.

The term “alkoxy” refers to an alkyl radical which is attached to an oxygen atom, i.e. —O—CₙH₂ₙ₊₁, to a molecule containing such a radical.

The term “halogen” refers to fluorine, chlorine, bromine, and iodine.

The term “substituted” refers to at least one hydrogen atom on the named radical being substituted with another functional group, such as halogen, —CN, or —NO₂. Besides the aforementioned functional groups, an aromatic group may also be substituted with alkyl or alkoxy. An exemplary substituted aryl group is methylphenyl.

The term “alkali metal” refers to lithium, sodium, and potassium.

The term “alkaline earth metal” refers to magnesium and calcium.

As used herein, the term “antimicrobial” means an agent that will kill or inhibit the growth of microorganisms, such as, for example, bacteria, viruses, and fungi.

As used herein, the term “disinfect” means to inactivate, kill, or otherwise render non-pathogenic a pathogen, such as, for example, a bacteria, virus, for fungus.

As used herein, the term “killing performance” refers to the ability of a composition to inactivate, kill, or otherwise render non-pathogenic a microorganism, and may be measured as a function of the reduction in viability of a particular microorganism. The term “killing performance” may also have a time/duration dimension (i.e. killing performance at 24 hours, 48 hours, 72 hours, etc.).

T. gondii (i.e., Toxoplasma gondii) is a protozoan parasite that infects most species of warm-blooded animals, including humans, and causes the disease toxoplasmosis. Domestic cats and their relatives are definitively known to carry and spread T. gondii, such as via unsporulated oocysts that are shed in the cat's feces. While oocysts may only be shed for several weeks (e.g., about 1-3 weeks), hundreds of millions may be shed at a time. These oocysts are difficult to kill, take only about 1-5 days to sporulate in the environment and become infective, and can remain viable for at least a year and a half under certain conditions. Intermediate hosts in nature (including other animals such as birds, rodents, even humans) may become infected after ingesting soil, water or plant material contaminated with oocysts.

Animal feces may also carry other harmful microorganisms, such as Staphylococcus, Salmonella, Yersinia, Campylobacter, E. coli, and Giardia, among others.

Staphylococcus aureus (i.e. S. aureus) is a gram-positive bacteria commonly found on skin and in the nasopharynx. It can infect any human tissue, invade the body, and cause death. It is a leading cause of bacterial infections and death due to bacterial infections. Antibiotic treatment of S. aureus infection is complicated by widespread drug-resistance (MRSA, VRSA).

Salmonella is a bacteria that typically lives in animal and human intestines and is shed through feces. Salmonella causes salmonellosis, a common bacterial disease that affects the intestinal tract. Humans become infected most frequently through contaminated water or food, but pets can spread Salmonella through shared litter boxes, when roaming throughout the house, through licking, or after stool accidents inside the home.

Yersinia describes a class of bacteria with approximately 11 species, of which three species are known to cause human disease, including Yersinia enterocolitica, Yersina pseudotuberculosis and Yersinia pestis. Y. enterocolitica is a small anaerobic Gram-negative bacteria and it primarily causes infections of the gastrointestinal tract in humans. Yersinia is widely dispersed in nature and can be found in fresh water samples, food and in a wide range of animals, including domestic animals. Transmission to humans occurs through contaminated food or water, and domestic animals have been known to be the source of infection in humans.

Campylobacter is a type of gram-negative bacteria, some species of which can infect humans and cause campylobacteriosis. Animals such as domesticated pets can be a source of infection as they often carry Campylobacterasymptomatically

Giardia is a type of parasite that lives and reproduces in the intestines of humans and animals, causing giardiasis. Humans or other animals can become infected by ingesting or coming into contact with contaminated foods, soil, or water tainted by the feces of an infected carrier.

### Animal Litter and Bedding Materials

The animal-related materials (e.g., animal litter and animal bedding) of the present disclosure, which are used to form a final surface or structure, generally comprise: (A) an active composition including at least one halo active aromatic sulfonamide compound, as described herein; and (B) a base material. As described further below, the halo active aromatic sulfonamide compound(s) may be variously incorporated in different states and the base material may comprise a variety of natural and/or synthetic components.

The halo active aromatic sulfonamide compound(s) of the active composition (A) used in the animal-related materials of the present disclosure may have the structure of base Formula (I):

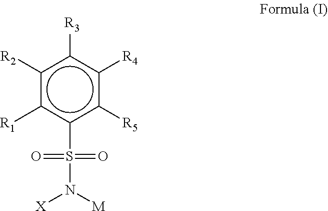

wherein R₁, R₂, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;

wherein R₃ is COOH, COOM₁, COOR′, or CON(R″)₂;

R′ is hydrogen, an alkali metal, an alkaline earth metal, substituted C₁-C₁₈ alkyl, or unsubstituted C₁-C₁₈ alkyl; and

R″ is hydrogen or substituted or unsubstituted C₁-C₁₈ alkyl, where the two R″ groups in CON(R″)₂ and N(R″)₂ may be independently selected;

X is halogen; and

M and M₁ are independently an alkali or alkaline earth metal.

The term “aromatic”, as used herein, does not refer to a smell detected by the nose.

Generally, M is sodium or potassium. X is generally chlorine, bromine, fluorine, or iodine, and in particular embodiments is chlorine. Compounds of Formula (I) may or may not be hydrated. When hydrated, each molecule of the sulfonamide compound may be hydrated with up to 100 water molecules, or even more. In particular embodiments, the compounds of Formula (I) are a trihydrate (i.e., n=3) or a hexahydrate (i.e. n=6). In other embodiments, the compound is in a solid form, such as a powder.

When the phenyl and/or alkyl group is substituted, one or more hydrogen atoms may be independently replaced with hydroxyl or halogen.

In particular embodiments of Formula (I), R₃ is COOH or COOM₁; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; and M₁ is an alkali or alkaline earth metal.

In further embodiments, R₃ is COOH or COOM₁; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M₁ is an alkali or alkaline earth metal; and at least one of R₁, R₂, R₄, and R₅ is not hydrogen.

In yet other embodiments of Formula (I), R₃ is selected from COOH, COOM₁, COOR′, CON(R″)₂, CN, NO₂, and halogen; R₁, R₂, R₄, and R₅ are independently selected from hydrogen, COOH, COOM₁, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; and M is an alkali or alkaline earth metal.

In yet other embodiments of Formula (I), R₂ and R₄ are hydrogen; and R₁, R₃, and R₅ are identical to each other.

In more specific embodiments of Formula (I), R₃ is selected from COOH, COOM₁, COOR′, and CON(R″)₂. Most desirably, R₃ is COOH or COOM₁, while R₁, R₂, R₄, and R₅ are hydrogen.

In other embodiments of Formula (I), R₁, R₂, R₄, and R₅ are independently selected from hydrogen, COOH, COOM₁, COOR′, CON(R″)₂, NO₂, halogen, N(R″)₂, substituted or unsubstituted C₁-C₁₈ alkyl, and substituted or unsubstituted aromatic; wherein at least one of R₁, R₂, R₄, and R₅ is not hydrogen; X is halogen; M is an alkali or alkaline earth metal; and n is the number of water molecules per molecule of the sulfonamide compound.

In still other embodiments of Formula (I), R₃ is COOH or COOM₁; R₁, R₂, R₄, and R₅ are independently selected from hydrogen, NO₂, halogen, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound. In further specific embodiments, at least one of R₁, R₂, R₄, and R₅ is not hydrogen.

In some embodiments of Formula (I), at least one of R₁, R₂, R₄, or R₅ are not hydrogen. In more specific embodiments of Formula (I), at least two of R₁, R₂, R₄, or R₅ are not hydrogen. In other words, the benzene ring contains the sulfonamide substituent, a substituent at R₃, and an additional one or two other substituents.

In other embodiments of Formula (I), the halo active aromatic sulfonamide compound has the structure of Formula (II):

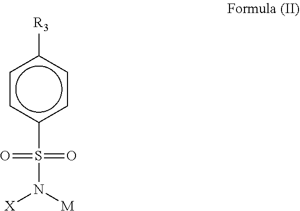

wherein R₃ is COOR′; R′ is hydrogen, an alkali metal, an alkaline earth metal, substituted C₁-C₁₈ alkyl, unsubstituted C₁-C₁₈ alkyl, substituted aromatic, or unsubstituted aromatic; X is halogen; and M is an alkali or alkaline earth metal. The N-chloro-4-carboxybenzenesulfonamide compound of Formula (II) is also referred to herein as BENZ. BENZ exhibits a lower chlorine smell than chloramine-T or chloramine-B. When BENZ is combined with at least one fragrance, there is no detectable chlorine smell for most humans. The compound BENZ is shown below as Formula (III):

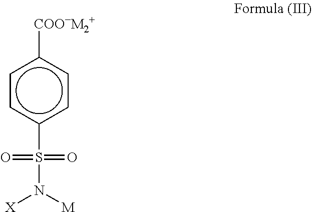

wherein M₂ is hydrogen, an alkali metal, or an alkali earth metal; X is halogen, and M is independently an alkali or alkaline earth metal. Desirably, M₂ is hydrogen, sodium, or potassium.

In other particular embodiments, one or more of R₁, R₂, R₃, R₄, and R₅ are substituted with —COOR′ (and the others are hydrogen). In this regard, it is believed that when the halo active aromatic sulfonamide compound has two or more ionic charges, that the compound has higher antimicrobial and odor control performance. The antimicrobial performance of these compounds of Formula (I) was not expected, because sulfonamide groups having a halogen atom bonded to the nitrogen atom are not present in molecules having known antimicrobial or odor control properties.

The halo active aromatic sulfonamide compounds of Formula (I) are stable, very soluble in water, do not decompose in aqueous solution, low in toxicity, and have minimal bleach odor.

The halo active aromatic sulfonamide compound may be present in the active composition (A) in the amount of about 1 wt % to about 99.9 wt % based on the weight of the active composition, such as from about 1 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, and from about 90 wt % to about 99.9 wt %, including any combination of endpoints thereof, based on the weight of the active composition.

In some embodiments, the active composition (A) can further comprise various additional additives, such as acrylics, latexes, polyvinyl acetates, ethyl vinyl acetates, celluloses, surfactants, alcohols, pH stabilizers, thickeners, sealers, cleaners, alkanolamines, water-retentive additives, pigments, polymer additives, paper and/or fiberglass fibers, plasticizers, foaming agents, starch, ground mica, chelating agents, anti-mildew agents, wax emulsions or silanes, potassium sulfate, and/or combinations thereof. In further embodiments, the active composition (A) comprises from about 0 wt % to about 20 wt % of these additional additives based on the total weight of the active composition (A), including from about 0 wt % to about 0.01 wt %, or from about 0.01 wt % to about 0.1 wt %, or from about 0.1 wt % to about 1 wt %, or from about 1 wt % to about 2 wt %, or from about 2 wt % to about 3 wt %, or from about 3 wt % to about 4 wt %, or from about 4 wt % to about 5 wt %, or from about 5 wt % to about 10 wt %, or from about 10 wt % to about 15 wt %, or from about 15 wt % to about 20 wt %, or any combination of endpoints thereof.

In further embodiments, the remainder or balance of the active composition (A) may consist essentially of water. Alternatively, the active composition (A) can be dry (i.e., substantially free of water or moisture).

The halo active aromatic sulfonamide compound may be present in the animal litter or bedding (or portions thereof) in the amount of about 0.0001 wt % to about 40 wt %, based on the weight of the litter or bedding. It is contemplated that the halo active aromatic sulfonamide compound may be present in the animal litter/animal bedding in different forms, such as in a solution, as a dry powder, as a dry crystal, as dry pellets, and/or as a dry coating. It is contemplated that the animal-related products (e.g., animal litter) can be sold as a dry powder or dehydrated formulation that subsequently becomes hydrated (i.e., activated) when exposed to moisture, such as moisture from animal urine and/or animal feces. The halo active aromatic sulfonamide compound is present in larger amounts when the composition is in the dry powder form, and the amount is subsequently reduced when moisture is added to the dry powder. In particular embodiments, the halo active aromatic sulfonamide compound is present in the form of a powder, having an average particle size of 50 micrometers (μm) or less. The powder typically has a minimum particle size of about 10 nanometers (μm). Common methods for measuring particle size and distribution include dynamic image analysis (DIA), static laser light scattering (SLS, also called laser diffraction), dynamic light scattering (DLS) and sieve analysis. The average particle size refers to the D50, the size below which 50% of all particles are found. The particle size distribution is generally considered to be Gaussian

In further embodiments, the halo active aromatic sulfonamide compound may be present in the animal litter and/or animal bedding in the amount of about 0.0001 wt % to about 0.001 wt %, or about 0.001 wt % to about 0.002 wt %, or about 0.002 wt % to about 0.003 wt %, or about 0.003 wt % to about 0.004 wt %, or about 0.004 wt % to about 0.005 wt %, or about 0.005 wt % to about 0.006 wt %, or about 0.006 wt % to about 0.007 wt %, or about 0.007 wt % to about 0.008 wt %, or about 0.008 wt % to about 0.009 wt %, or about 0.009 wt % to about 0.01 wt %, or about 0.01 wt % to about 0.02 wt %, or about 0.02 wt % to about 0.03 wt %, or about 0.03 wt % to about 0.04 wt %, or about 0.04 wt % to about 0.05 wt %, or about 0.05 wt % to about 0.06 wt %, or about 0.06 wt % to about 0.07 wt %, or about 0.07 wt % to about 0.08 wt %, or about 0.08 wt % to about 0.09 wt %, or about 0.09 wt % to about 0.1 wt %, or about 0.1 wt % to about 0.2 wt %, or about 0.2 wt % to about 0.3 wt %, or about 0.3 wt % to about 0.4 wt %, or about 0.4 wt % to about 0.5 wt %, or about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1 wt %, or about 1 wt % to about 5 wt %, or about 5 wt % to about 10 wt %, or about 10 wt % to about 35 wt %, or about 10 wt % to about 20 wt %, or about 20 wt % to about 30 wt %, or about 30 wt % to about 40 wt %, or any combination of endpoints thereof, based on the weight of the animal litter/animal bedding.

In some embodiments, the halo active aromatic sulfonamide compound may be present in the final structure (litter/bedding) in the amount of about 0.0001 wt % to about 40 wt %, based on the weight of the structure formed, including from about 0.0001 wt % to about 0.001 wt %, from about 0.001 wt % to about 0.01 wt %, from about 0.01 wt % to about 0.1 wt %, from about 0.1 wt % to about 1 wt %, from about 1 wt % to about 5 wt %, from about 5 wt % to about 10 wt %, from about 10 wt % to about 20 wt %, from about 20 wt % to about 30 wt %, or from about 30 wt % to about 40 wt %, or any combination of endpoints thereof, based on the weight of the structure formed.

As mentioned above, the animal-related material compositions of the present disclosure typically include a base material (B). In certain embodiments, such as where the animal-related material is an animal litter, the base material (B) may include at least an absorbent component that absorbs liquid and moisture (e.g., from urine or feces). In other embodiments, such as when the animal-related material is animal bedding, the base material (B) may include at least a textile component, such as some type of woven fabric or material. In specific embodiments, the base material (B) can comprise, for example and without limitation, tree pulp, tree leaves, grasses, paper products, clay, dirt, rock, fleece, aspen, cardboard, sand, carpet, herbs, absorbent pads, hemp, cotton, wool, polyester, fleece, flannel, denim, faux suede, microfiber, polyurethane, cedar chips, straw, and the like.

In further embodiments, the base material (B) comprises one or more of these components, each component being present in an amount of from about 0.1 wt % to about 99 wt % based on the total weight of the base material (B), including from about 5 wt % to about 10 wt %, or from about 10 wt % to about 20 wt %, or from about 20 wt % to about 30 wt %, or from about 30 wt % to about 40 wt %, or from about 40 wt % to about 50 wt %, or from about 50 wt % to about 60 wt %, or from about 60 wt % to about 70 wt %, or from about 70 wt % to about 80 wt %, or from about 80 wt % to about 85 wt %, or from about 85 wt % to about 90 wt %, or from about 90 wt % to about 95 wt %, or from about 95 wt % to about 99 wt %, or any combination of endpoints thereof.

When the base material is used as an animal litter, particular examples of the base material include clay, sand (silica), corn cob, wood shavings or chips, and super absorbent polymers. Specific types of clay include bentonite clay and montmorillonite clay. It is noted that such clays can contain other minerals such as feldspar, quartz, gypsum, dolomite, mica, or calcite, which are typically in minor amounts (less than 20 wt % overall). Fillers such as feldspar, quartz, gypsum, dolomite, mica, calcite, limestone, or sand may be used as an additional additive to the animal litter. Clumping agents may also be used as an additional additive to the animal litter, such as starch, carbohydrates like dextrin, or other binders like guar gum, xanthan gum, gum Arabic, or gum acacia.

In particular embodiments, the base material has an average particle size of 100 micrometers (μm) to about 2000 μm, or from about 100 μm to about 1000 μm.

The base material (B) may be present in the animal litter/animal bedding in the amount of about 1 wt % to about 99.99 wt %, based on the total weight of the litter or bedding. In further embodiments, the base material (B) may be present in the amount of about 50 wt % to about 99.99 wt %, or about 50 to about 99 wt %, or any combination of endpoints thereof, based on the total weight of the litter or bedding. In still further embodiments, the base material (B) may be present in the amount of about 10 wt % to about 20 wt %, or about 20 wt % to about 30 wt %, or about 30 wt % to about 40 wt %, or about 40 wt % to about 50 wt %, or about 50 wt % to about 60 wt %, or about 60 wt % to about 70 wt %, or about 70 wt % to about 80 wt %, or about 80 wt % to about 85 wt %, or about 85 wt % to about 90 wt %, or about 90 wt % to about 91 wt %, or about 91 wt % to about 92 wt %, or about 92 wt % to about 93 wt %, or about 93 wt % to about 94 wt %, or about 94 wt % to about 95 wt %, or about 95 wt % to about 96 wt %, or about 96 wt % to about 97 wt %, or about 97 wt % to about 98 wt %, or about 98 wt % to about 99 wt %, or about 99 wt % to about 99.99 wt %, or any combination of endpoints thereof, based on the total weight of the animal litter and/or bedding. In specific embodiments, the base material may be present in the amount of at least 50 wt %, or at least 60 wt %, or at least 70 wt %, or at least 80 wt %, or at least 90 wt %, based on the total weight of the animal litter and/or bedding

When the animal-related material is an animal bedding, specific examples of the base material (B) include, for example and without limitation, blankets, pillows or pads, or portions thereof (e.g., linings for such structures).

The active composition (A) containing the halo active aromatic sulfonamide compound and the base material (B) can be combined in a variety of manners. For example, the active composition (A) containing the halo active aromatic sulfonamide compound may be applied and/or otherwise incorporated into the base material (B) using a variety of processes, including crystals, powders, pellets, spray, soaking, and coating.

### Methods of Treating Animal Litter and Bedding Materials

Also disclosed herein are methods of treating animal litter and animal bedding materials in order to provide an animal-related product that exhibits and maintains significant antimicrobial effects over extended periods of time.

In accordance with a first embodiment of the present disclosure, a method of preparing animal litter having extended antimicrobial killing performance is disclosed. An animal litter is provided. Then, the animal litter or a portion thereof is treated with an active composition comprising a halo active aromatic sulfonamide compound. The halo active aromatic sulfonamide compound may have a chemical structure as described above, and the active composition may further include one or more additional additives. The active composition used to treat the animal litter may be either a dry formulation (i.e., substantially free from water and/or moisture) or a wet formulation (i.e., as a solution containing water and/or another solvent). The animal litter can be treated with the active composition using a variety of methods, such as through spraying, soaking, coating, mixing, tumbling, blending, beating, sifting, and stirring the active composition into or with the animal litter.

For example, as a dry formulation, the active composition may be in the form of crystals, powders, and/or pellets that are blending, tumbled, sifted, or otherwise applied to the surface of the animal litter particles. Alternatively, as a wet formulation, the active composition may be sprayed onto the animal litter or used to soak the animal litter.

In further embodiments, the treated animal litter may be dried. In certain embodiments, the treated animal litter may be dried at room temperature. In other embodiments, the treated animal litter may be dried by heating the treated animal litter to a temperature above room temperature for a period of time.

In accordance with a second embodiment of the present disclosure, a method of preparing animal bedding having extended antimicrobial killing performance is disclosed. An animal bedding or at least a portion of the animal bedding is provided. The animal bedding or a portion thereof is then treated with an active composition comprising a halo active aromatic sulfonamide compound. The halo active aromatic sulfonamide compound may have a chemical structure as described above, and the active composition may further include one or more additional additives. The active composition used to treat the animal bedding may be either a dry formulation (i.e., substantially free from water and/or moisture) or a wet formulation (i.e., as a solution containing water and/or another solvent). The animal bedding can be treated with the active composition using a variety of methods, such as through spraying, soaking, coating, mixing, tumbling, blending, beating, sifting, and stirring the active composition into or with the animal litter.

The animal bedding or the portion of the animal bedding may include, for example, an outer covering, a removable cover, a blanket, a sheet or layer of fabric, an internal pad or foam or other kind of filling, and the like. In particular embodiments, the portion of the animal bedding that is treated with the active composition comprises woven fibers, and the active composition is used to coat the woven fibers. In further embodiments, the active composition may be dispersed within the structure of the treated portion of the animal bedding (e.g., dispersed between the woven fibers or within a porous foam structure, for example).

In further embodiments, the treated animal bedding may be dried. In certain embodiments, the treated animal bedding may be dried at room temperature. In other embodiments, the treated animal bedding may be dried by heating the treated animal bedding to a temperature above room temperature for a period of time. Additionally, portions of the animal bedding may be provided, treated, and then subsequently assembled into a completed animal bedding.

It is contemplated the animal litter and/or bedding containing the halo active aromatic sulfonamide compound can be exposed to water/moisture that hydrates the sulfonamide compound and permits its active antimicrobial and odor control ability. Water may also be present via the hydrated sulfonamide compound itself.

While not being limited by theory, it is believed that minor amounts of water, either through the hydrated nature active sulfonamide compound and/or the ambient humidity, will keep the sulfonamide active over an extended period of time compared to other products such as bleach. Thus, the antimicrobial kill performance and/or odor-eliminating performance of the sulfonamide will extend over that time period as well, so that repeated exposure of microorganisms or odor-causing molecules will also be eliminated, even after drying. Extended kill and prophylactic protection of surfaces and structures is thus possible for times of up to 2 weeks, one month, multiple months, or one year, or even multiple years as previously described herein, as long as the sulfonamide compound is not exhausted or decomposed or degraded. In contrast, traditional forms of protection (e.g., simply washing, etc.) provide little, if any, residual protection: if new microorganisms are applied to the surface after the product has dried, those new microorganisms will survive and reproduce. This lack of residual protection by known products is substantially different from the compositions presently disclosed herein.

Generally, the animal litter will be used by providing a container containing the animal litter. Such containers are commonly known as litter boxes and typically include a base with four vertical walls for containing the animal litter. The container may also include an enclosure with a top and an opening through which the animal enters the litter box. Animals such as cats, rabbits, gerbils, hamsters, guinea pigs, mice, rats, ferrets, etc., may use such litter boxes. Next, an animal is permitted to excrete waste (e.g. urine or feces) into the animal litter. In some embodiments, the animal litter may clump with the animal waste, and the clump can then be scooped or otherwise removed from the litter box.

As described herein, the surfaces and structures formed by the present animal-related materials can be effective to achieve extended kill and prophylactic protection, including with respect to a variety of microorganisms, including, for example, Staphylococcus aureus, T. gondii, Salmonella, Yersinia, Campylobacter, and Giardia, among others. The structures and surfaces formed from the animal-related material compositions of the present disclosure may achieve high microbial killing and/or odor-reducing performance over extended periods of time. In particular embodiments, the structures and surfaces can maintain a killing performance of at least 85% after 24 hours, or at least 90% after 24 hours, or at least 95% after 24 hours, or at least 98% after 24 hours, or at least 85% after 48 hours, or at least 90% after 48 hours, or at least 95% after 48 hours, or at least 98% after 48 hours, or at least 85% after 72 hours, or at least 90% after 72 hours, or at least 95% after 72 hours, or at least 98% after 72 hours, or at least 85% after 168 hours, or at least 90% after 168 hours, or at least 95% after 168 hours, or at least 98% after 168 hours, or at least 85% after 336 hours, or at least 90% after 336 hours, or at least 95% after 336 hours, or at least 98% after 336 hours.

The following examples are provided to illustrate the compositions, methods, articles, and properties of the present disclosure. The examples are merely illustrative and are not intended to limit the disclosure to the materials, conditions, or process parameters set forth therein.

### EXAMPLES

### Example 1

A solution was made that contained about 2 wt % N-chloro-4-carboxybenzenesulfonamide compound (BENZ), 98 wt % water, and sodium bicarbonate as a pH buffer. The solution was mixed with an acrylic (ACR) coating to form a coating composition. The coating composition was applied to a glass surface, then allowed to dry to form a coating film.

The coating film was then artificially aged for 150 hours at 55° C. This simulated a passage of time of over six months. The stability of the BENZ was then tested.

An organic indicator was then applied to the coating film. The organic indicator contained a compound that reacts with the BENZ, and represents an organic substance. The organic indicator began changing color, with the intensity of the orange color corresponding to the total amount of the organic substance reacting with the BENZ. When the color ceased changing, this represented the total eradication of the organic substance.

The ACR coating containing the BENZ molecule completely reacted with the organic substance in about two minutes. The completely reacted organic indicator was removed from the coating, and new organic indicator was applied. The new organic indicator also changed color, indicating that the BENZ was not completely used up after the first application.

### Example 2

The solution containing 2 wt % BENZ was made as in Example 1. The solution was mixed with a styrene-butadiene polymer (SBD) to form a coating composition. The coating composition was applied to a glass surface, then allowed to dry to form a coating film. The coating film was then artificially aged for 150 hours at 55° C. The stability of the BENZ was then tested.

An organic indicator was then applied to the coating film as in Example 1. The SBD coating containing the BENZ molecule completely reacted with the organic substance in about 30 minutes.

### Example 3

Test swatches which had been impregnated with 2.5% BENZ were exposed to Staphylococcus aureus, Pseudomonas aeruginosa, and Aspergillus brasiliensis. A stack of two swatches was placed in a petri dish and then inoculated with 1.000 mL of an inoculum for one of the microorganisms. Following inoculation, the petri dishes were sealed and placed in a plastic bag/container, then incubated at optimal conditions for the given microorganism. Swatches were harvested at 0, 10 minutes, 30 minutes, 1 hour, and 6 hours after inoculation.

At harvesting, the swatch was transferred to a neutralization media, then vortex mixed for 1-2 minutes. The neutralization suspension was numbered and plated for 18-24 hours for bacteria and 24-72 hours for fungi at optimal incubation conditions.

As to S. aureus, 99.999% kill was obtained within 30 minutes.

As to P. aeruginosa, 99.999% kill was obtained within 10 minutes.

As to A. brasiliensis, 99.9% kill was obtained within 1 hour.

A similar test was run with Candida auris. A stack of four swatches was placed in a petri dish and then inoculated with 1.000 mL of the inoculum. Following inoculation, the petri dishes were sealed and placed in a plastic bag/container, then incubated at optimal conditions. 99.998% kill was obtained within 1 hour.

Next, a filter medium impregnated with 2.5% BENZ was exposed to a 0.200 mL volume of Rhinovirus 37, 151-1 strain, ATCC VR-1607 for a contact time of 30 minutes at 24.7-24.9° C. and 39.9-40.5% relative humidity.

After 30 minutes, the filter medium was transferred to a neutralization medium and vortexed for at least 15 seconds. A 0.1 mL aliquot was removed and a series of 10-fold dilutions was performed in 0.9 mL aliquots of test medium. Each dilution was inoculated into MRC-5 cells. Viral titer was then calculated. The TCID₅₀ represents the endpoint dilution where 50% of the cell cultures exhibited cytopathic effects, and was determined using the Spearman-Karber method. The BENZ filter medium demonstrated a >99.997% reduction in viral titer.

A similar experiment was performed with Influenza A virus, A/PR/8/34 strain, ATCC VR-1469. The BENZ filter medium demonstrated a >99.99997% reduction in viral titer.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. An antimicrobial and odor-reducing animal litter, comprising:
an absorbent base material; and
a halo active aromatic sulfonamide compound of Formula (I): 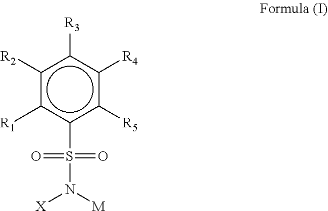
wherein R₁, R₂, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; and
wherein R₃ is COOH, COOM₁, COOR′, or CON(R″)₂;
wherein R′ is hydrogen, an alkali metal, an alkaline earth metal, substituted C₁-C₁₈ alkyl, or unsubstituted C₁-C₁₈ alkyl; and
wherein R″ is hydrogen or substituted or unsubstituted C₁-C₁₈ alkyl, where the two R″ groups in CON(R″)₂ and N(R″)₂ may be independently selected from each other;
X is halogen; and
M and M₁ are independently an alkali or alkaline earth metal.

2. The animal litter of claim 1, wherein the halo active aromatic sulfonamide compound is N-chloro-4-carboxybenzenesulfonamide.

3. The animal litter of claim 1, wherein the animal litter comprises from about 0.01 wt % to about 20 wt % of the halo active aromatic sulfonamide compound.

4. The animal litter of claim 1, wherein the absorbent base material has an average particle size of 100 micrometers (μm) to about 2000 μm.

5. The animal litter of claim 1, wherein the halo active aromatic sulfonamide compound is in the form of a powder having an average particle size of 50 micrometers (μm) or less.

6. The animal litter of claim 1, wherein the animal litter further comprises from about 0.01 wt % to about 20 wt % of an additional additive.

7. The animal litter of claim 6, wherein the additional additive is an acrylic, a latex, a polyvinyl acetate, a cellulose, a surfactant, an alcohol, a pH stabilizer, a thickener, a sealer, a cleaner, a pigment, or a water-retentive additive.

8. A method for treating animal waste, comprising:
providing a container containing an animal litter;
permitting an animal to excrete waste into the animal litter;
wherein the animal litter comprises an absorbent base material and a halo active aromatic sulfonamide compound of Formula (I): 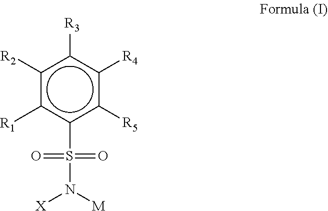
wherein R₁, R₂, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; and
wherein R₃ is COOH, COOM₁, COOR′, or CON(R″)₂;
wherein R′ is hydrogen, an alkali metal, an alkaline earth metal, substituted C₁-C₁₈ alkyl, or unsubstituted C₁-C₁₈ alkyl; and
wherein R″ is hydrogen or substituted or unsubstituted C₁-C₁₈ alkyl, where the two R″ groups in CON(R″)₂ and N(R″)₂ may be independently selected from each other;
X is halogen; and
M and M₁ are independently an alkali or alkaline earth metal.

9. The method of claim 8, wherein the halo active aromatic sulfonamide compound is N-chloro-4-carboxybenzenesulfonamide.

10. The method of claim 8, wherein the animal litter comprises from about 0.01 wt % to about 20 wt % of the halo active aromatic sulfonamide compound.

11. The method of claim 8, wherein the absorbent base material has an average particle size of 100 micrometers (μm) to about 2000 μm, and the halo active aromatic sulfonamide compound is in the form of a powder having an average particle size of 50 micrometers (μm) or less.

12. A method of preparing animal litter or bedding to have extended antimicrobial killing performance, the method comprising:
treating the animal litter or bedding with an active composition comprising a halo active aromatic sulfonamide compound, wherein the halo active aromatic sulfonamide compound has a chemical structure according to Formula (I): 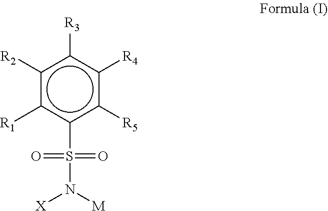
wherein R₁, R₂, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; and
wherein R₃ is COOH, COOM₁, COOR′, or CON(R″)₂;
wherein R′ is hydrogen, an alkali metal, an alkaline earth metal, substituted C₁-C₁₈ alkyl, or unsubstituted C₁-C₁₈ alkyl; and
wherein R″ is hydrogen or substituted or unsubstituted C₁-C₁₈ alkyl, where the two R″ groups in CON(R″)₂ and N(R″)₂ may be independently selected from each other;
X is halogen; and
M and M₁ are independently an alkali or alkaline earth metal.

13. The method of claim 12, wherein treating the animal litter or bedding with the active composition includes spraying the active composition onto at least a portion of the animal litter or bedding, or combining the active composition with the animal litter or bedding by mixing, coating, tumbling, blending, beating, sifting, or stirring.

14. The method of claim 12, wherein the method further comprises:
drying the animal litter or bedding after treatment with the active composition.

15. The method of claim 12, wherein the halo active aromatic sulfonamide compound is N-chloro-4-carboxybenzenesulfonamide.

16. An antimicrobial and odor-reducing animal bedding, comprising:
a textile base material; and
a halo active aromatic sulfonamide compound of Formula (I): 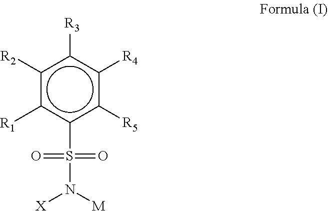
wherein R₁, R₂, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; and
wherein R₃ is COOH, COOM₁, COOR′, or CON(R″)₂;
wherein R′ is hydrogen, an alkali metal, an alkaline earth metal, substituted C₁-C₁₈ alkyl, or unsubstituted C₁-C₁₈ alkyl; and
wherein R″ is hydrogen or substituted or unsubstituted C₁-C₁₈ alkyl, where the two R″ groups in CON(R″)₂ and N(R″)₂ may be independently selected from each other;
X is halogen; and
M and M₁ are independently is an alkali or alkaline earth metal.

17. The animal bedding of claim 16, wherein the halo active aromatic sulfonamide compound is N-chloro-4-carboxybenzenesulfonamide.

18. The animal bedding of claim 16, wherein the animal bedding comprises from about 1 wt % to about 99.9 wt % of the halo active aromatic sulfonamide compound.

19. The animal bedding of claim 16, wherein the animal bedding further comprises one or more additional additives selected from the group consisting of: an acrylic, a latex, a polyvinyl acetate, a cellulose, a surfactant, an alcohol, a pH stabilizer, a thickener, a sealer, a cleaner, a pigment, and a water-retentive additive.

20. The animal bedding of claim 16, wherein the animal bedding comprises from about 50 wt % to about 99.99 wt % of the textile base material.
